(19) United States
(12) Patent Application Publication
(10) Pub. No.: US 2013/0283842 A1
(43) Pub. Date: Oct. 31, 2013

(54) CLIMATE-CONTROL DEVICE FOR A VEHICLE, AND METHOD FOR REGULATING A CLIMATE IN A PASSENGER COMPARTMENT OF A VEHICLE

(71) Applicants: Joerg Heyse, Besigheim (DE); Anton Dukart, Gerlingen (DE); Thomas Demmer, Stuttgart (DE); Martin Fischer, Leonberg (DE); Jens Ritzert, Gerlingen (DE); Michael Ritter, Schwieberdingen (DE)

(72) Inventors: Joerg Heyse, Besigheim (DE); Anton Dukart, Gerlingen (DE); Thomas Demmer, Stuttgart (DE); Martin Fischer, Leonberg (DE); Jens Ritzert, Gerlingen (DE); Michael Ritter, Schwieberdingen (DE)

(73) Assignee: ROBERT BOSCH GMBH, Stuttgart (DE)

(21) Appl. No.: 13/997,652

(22) PCT Filed: Nov. 29, 2011
(86) PCT No.: PCT/EP2011/071277

§ 371 Date: Jun. 24, 2013

(30) Foreign Application Priority Data
Dec. 23, 2010 (DE) 10 2010 064 134.0

(51) Int. Cl. B60H 1/32; B60H 1/02; B60H 3/06; B60H 1/00

(52) U.S. Cl. CPC B60H 1/3201; B60H 1/00328; B60H 1/02; B60H 3/06
USPC 62/324.2; 165/43; 62/244

(57) ABSTRACT

The invention relates to a climate-control device (501) for a vehicle, having a thermal energy store (1105), wherein a gas recycler (1301) is formed for conditioning a gas mixture which is situated in a passenger compartment (1103) of the vehicle (1101). Furthermore, the invention relates to a method for regulating a climate in a passenger compartment (1103) of a vehicle (1101).

### BACKGROUND OF THE INVENTION

The invention relates to a climate-control device for a vehicle. The invention furthermore relates to a method for regulating a climate in a passenger compartment of a vehicle.

Adsorption heat exchangers for mobile applications in passenger compartment heating and cooling are known per se. Thus, for example, patent EP 1 809 499 B1 describes an adsorption heat pump for climate control in a motor vehicle.

However, the disadvantage of the known devices is that they can only provide a heating or cooling capacity. In a recirculated air mode, that is to say when no fresh air is fed to a space to be cooled or heated, e.g. a passenger compartment, the air quality in the space, e.g. the passenger compartment, decreases as the time duration increases. In particular, a carbon dioxide content of the air increases while, at the same time, an oxygen content of the air falls. Moreover, a moisture content also increases due to respiration and transpiration by persons. In order to achieve an improvement in air quality, fresh air could be fed in from outside, for example. However, this fresh air must be cooled or heated in an involved process, depending on temperature, and this consumes additional energy. Particularly in the case of electric vehicles, this measure shortens a maximum possible range by up to 50% owing to the additional power consumption. In a vehicle with an internal combustion engine, fuel consumption rises due to this measure.

### SUMMARY OF THE INVENTION

The underlying object of the invention can therefore be considered that of specifying a climate-control device for a vehicle and a method for regulating a climate in a passenger compartment of a vehicle which overcomes the known disadvantages and ensure good air quality in the passenger compartment while, at the same time, consuming little power and/or fuel.

According to one aspect, a climate-control device is provided for a vehicle. The climate-control device comprises a thermal energy store. A gas recycler for conditioning a gas mixture situated in a passenger compartment of the vehicle is furthermore formed. The gas mixture is preferably air. To this extent, the gas recycler can then also be referred to as an air recycler.

According to another aspect, a method for regulating a climate in a passenger compartment of a vehicle is provided. In this case, a gas mixture situated in the passenger compartment is conditioned. The gas mixture is preferably air.

By virtue of the fact that the gas mixture situated in the passenger compartment is conditioned, it is advantageously possible to ensure a constant quality of the gas mixture, with the result that less fresh air has to be fed in from outside. As a result, in particular, less heating or cooling capacity has to be provided, and this advantageously saves energy. Thus, a reduction in range of electric vehicles, as in the prior art, is mitigated. In the case of vehicles with an internal combustion engine, fuel consumption is advantageously reduced.

According to one embodiment, the gas recycler is coupled to the thermal energy store for the purpose of exchanging thermal energy. If, for example, the gas recycler takes thermal energy from the gas mixture when conditioning said mixture, this thermal energy can advantageously be stored in the thermal energy store in order, for example, to enable it to be reused at a later time to heat up the passenger compartment.

According to another embodiment, the thermal energy store has a cross flow heat exchanger. In a cross flow heat exchanger, the two media cross each other, exchanging thermal energy between them. An exchange of thermal energy is thereby advantageously maximized, especially if a fluid flow, in particular a gas flow, preferably an air flow, is involved in the heat exchange. As a consequence of this improved exchange of thermal energy, a weight and an overall size of the thermal energy store are advantageously minimized in relation to an energy content of the thermal energy store. As a result, it is advantageously possible to keep down a vehicle weight, increasing the range of the vehicle and/or consuming less fuel.

In another embodiment, the thermal energy store has an evaporator and an adsorber connected to the evaporator. The adsorber preferably contains an adsorbent, e.g. zeolite and/or silica gel. The evaporator preferably contains a working medium or adsorbed substance, e.g. water. The working medium is preferably deposited as water vapor (substance to be adsorbed) in the adsorbent and is referred to in the deposited form as adsorbate.

According to another embodiment, the evaporator and/or the adsorber contains a metal foam for holding a working medium or adsorbed substance. This advantageously makes it possible to enlarge a contact surface, thus enabling an exchange of thermal energy to be carried out in a particularly efficient way.

According to another embodiment, a valve for adjusting a cooling or heating capacity is arranged between the evaporator and the adsorber. In particular, the valve can interrupt the connection between the evaporator and the adsorber and/or restrict it in an infinitely variable manner. It is thus advantageously possible to adjust a heating capacity or cooling capacity of the climate-control device in a particularly accurate manner. In particular, the evaporator and the adsorber are connected by means of a duct. The valve is preferably formed as a shutoff valve and/or as a throttle valve.

According to another embodiment, the heating and/or the cooling capacity can be adjusted through a metered supply of water from a tank to the evaporator. For this purpose, use is preferably made of a metering pump, which is preferably arranged between the evaporator and the tank.

According to another embodiment, the heating and/or cooling capacity is adjusted by regulating a supply of cooling water to the adsorber by means of a water pump, thereby advantageously making it possible to influence the adsorber temperature and hence the rate of adsorption.

In another embodiment, the evaporator and/or the adsorber comprise a plurality of ducts arranged in parallel, in particular flat ducts, which are preferably designed as flat tubes. Fins, in particular louvered slot fins, are preferably arranged between the ducts. The fins can be arranged perpendicularly to the ducts and parallel to one another. The fins are preferably arranged in a sawtooth or triangle structure. The provision of fins advantageously enables a thermal exchange surface between two media to be increased. In particular, the fins are connected thermally to the ducts. The working medium, in particular water, is preferably introduced into the ducts of the evaporator. The adsorbent, preferably zeolite and/or silica gel, is preferably introduced into the ducts of the adsorber. For example, a fluid, in particular a gas, in particular air, can flow through the fins of the evaporator or adsorber at an angle>0° to the ducts and thus exchange thermal energy with the evaporator or adsorber. A thermal energy store comprising an adsorber and an evaporator with appropriate ducts can also be referred to in general as a flat-tube heat exchanger.

In another embodiment, the ducts can be filled with a metal foam. Provision can preferably also be made for the duct of the adsorber to be designed as a cast molding including the adsorbent. Thus, in particular, the duct can be cast together with a zeolite molding or be formed by the latter. As a preferred option, a surface of an inner side of the duct can be coated with the adsorbent, e.g. zeolite and/or silica gel. This advantageously improves thermal coupling of the adsorbent to the heat exchanger and thus increases the efficiency of the transfer of the heat output to an inlet air stream. In particular, the provision of a metal foam allows space-saving storage of the working medium while simultaneously providing a large evaporation surface so as to be able to withdraw the evaporation enthalpy from an air stream in an efficient manner. In particular, an embodiment having a metal foam allows space-saving storage of the working medium as a known microchannel evaporator.

In another embodiment, a nonwoven can be arranged in the ducts of the evaporator, allowing efficient storage of the working medium, e.g. water, in an advantageous manner.

In another embodiment, an adsorption heat pump (adsorption refrigeration unit) can be coupled to the thermal energy store and/or to the gas recycler for the purpose of exchanging thermal energy. In particular, the adsorption heat pump is used to cool an air stream. It is thus advantageously possible to increase a coefficient of performance (COP) and, in particular, it is possible to achieve a COP greater than 1. This COP indicates how much useful power (heating or cooling) is available for the amount of energy used. The energy used is electric energy taken from the power supply network during the charging of the vehicle. In the coupling between the energy store and the adsorption refrigeration unit, use is made of the fact that the energy store simultaneously makes available cold and heat. In this case, the cold is used directly to control the temperature of the interior, while the heat from the energy store is used to drive the adsorption refrigeration unit.

### BRIEF DESCRIPTION OF THE DRAWINGS

The invention is explained in greater detail below by means of preferred illustrative embodiments with reference to figures, of which:

FIG. 1 shows a flow diagram of one embodiment of a method for regulating a climate in a passenger compartment of a vehicle,

FIG. 2 shows a flow diagram of another method for regulating a climate in a passenger compartment of a vehicle,

FIG. 3 shows a climate-control device,

FIG. 4 shows another climate-control device,

FIG. 5 shows another climate-control device,

FIG. 6 shows a schematic diagram of a mode of operation of an evaporator and of an adsorber,

FIG. 7 shows one embodiment of a thermal energy store,

FIG. 8 shows one embodiment of an evaporator,

FIG. 9 shows one embodiment of a flat duct for an evaporator and/or an adsorber,

FIG. 10 shows another embodiment of a thermal energy store,

FIG. 11 shows a vehicle with a thermal energy store, wherein a passenger compartment of the vehicle is being heated,

FIG. 12 shows the vehicle from FIG. 11, wherein the passenger compartment is being cooled,

FIG. 13 shows the vehicle from FIGS. 11 and 12, additionally comprising a gas recycler,

FIG. 14 shows the vehicle from FIGS. 11 and 12 having a different embodiment of a thermal energy store (water-based system) and

FIG. 15 shows a thermal energy store which is coupled to an adsorption heat pump.

### DETAILED DESCRIPTION

In the text which follows, identical reference signs are used for identical features.

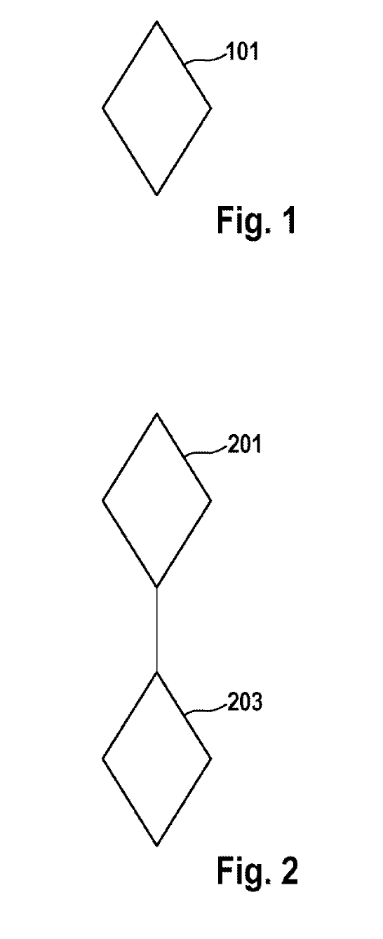

FIG. 1 shows one embodiment of a method for regulating a climate in a passenger compartment of a vehicle. In a step 101, a gas mixture situated in the passenger compartment is conditioned. The gas mixture is preferably air.

FIG. 2 shows another flow diagram of a method for regulating a climate in a passenger compartment of a vehicle. In a step 201, carbon dioxide is filtered out of the gas mixture. This filtering is preferably accomplished by means of an activated carbon filter and/or a molecular sieve. A molecular sieve preferably comprises a gas separation membrane. In this case, the gas mixture is preferably passed through the activated carbon filter or the molecular sieve. Regeneration of the activated carbon filter can preferably be accomplished by means of heating, in particular by means of electric heating. For an electric vehicle, regeneration preferably takes place during a loading mode, by means of energy from a power supply network, and not while driving. It is thus advantageously possible to avoid a reduction in range due to power consumption from the vehicle battery.

In a further step 203, moisture, in particular water vapor, is removed from the gas mixture. This moisture can arise, for example, from the breathing or transpiration of persons located in the passenger compartment. The moisture is preferably removed from the gas mixture by means of adsorption in zeolite or silica gel. The zeolite or silica gel can preferably be regenerated by means of heating, in particular by means of electric heating. For an electric vehicle, regeneration is preferably accomplished by means of energy from the power supply network during charging, not during driving, in order to avoid a reduction in range due to power consumption from the vehicle battery.

According to an embodiment which is not shown, a carbon dioxide content and/or an oxygen content and/or a moisture content of the gas mixture is monitored or checked by appropriately designed sensors. The conditioning of the gas mixture is then preferably controlled in an appropriate manner in accordance with the values detected by the sensors. In particular, a switch is made from a recirculated air mode, i.e. without a supply of fresh air to the passenger compartment from the outside, to a fresh air supply when critical values are reached. It is thus advantageously possible to ensure that an oxygen content or a carbon dioxide content always remains within permissible values, even if the gas recycler fails, thus avoiding any risk to the health of occupants of the passenger compartment. In an embodiment which is not shown, provision can furthermore be made for an ionizer to be formed, which can be switched on optionally. In particular, the ionizer ionizes oxygen in the air. A freshening effect of the air is thus advantageously intensified.

In another embodiment which is not shown, oxygen can additionally be fed into the passenger compartment. For example, the oxygen fed in can be supplied either by means of oxygen cylinders and/or by fractionating the external air by means of a molecular sieve.

In another embodiment which is not shown, pollutants and/or dust and/or pollen is/are removed from the gas mixture. This can preferably be accomplished by means of appropriate filters.

By virtue of the fact that, according to the invention, the gas mixture situated in the passenger compartment is conditioned, it is possible in general to prolong a recirculated air mode. It is thus not necessary, for example, for external air that would otherwise have to be fed into the passenger compartment in order to ensure a permissible oxygen content to be cooled or heated in an involved process. It is thus advantageously possible to achieve a significant increase in the range of an electric vehicle or a reduction in the fuel consumption of a vehicle with an internal combustion engine. Moreover, there are furthermore no losses of range due to dehumidification of the air in the interior. In addition, the windows can be kept free of mist, improving visibility through the windows, thus giving a driver a good view of other vehicles or obstacles.

In another embodiment which is not shown, odors are removed from the gas mixture, in particular through binding to an activated carbon filter. An atmosphere of well-being is thus advantageously achieved in the passenger compartment through conditioning of the air in the interior.

A limiting value for a CO2 content is preferably set to 0.15% by volume. An oxygen content is preferably set to 17% by volume, in particular 21% by volume. A relative air humidity is preferably <65%.

In general, the method according to the invention can also be used in a building in order to condition air in the building. Here too, energy can advantageously be saved in a similar way. The embodiments which have been described with reference to a vehicle also apply mutatis mutandis to a building. In general, the climate-control device according to the invention can also be used in a similar way in a building.

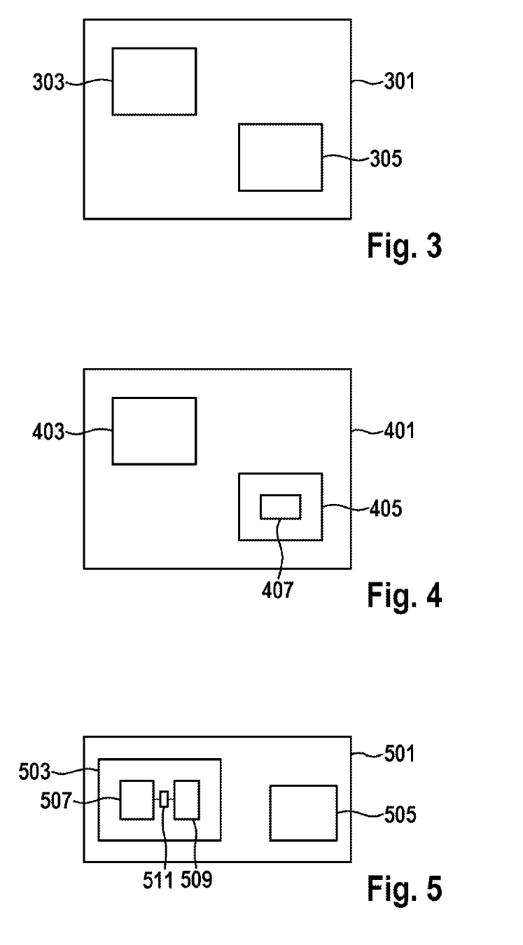

FIG. 3 shows a climate-control device 301 comprising a thermal energy store 303 and a gas recycler 305. The gas recycler 305 is, in particular, set up to condition a gas mixture (not shown) situated in a passenger compartment (not shown) of the vehicle (not shown). In an embodiment which is not shown, the thermal energy store 303 is thermally coupled to the gas recycler 305, allowing an exchange of thermal energy to take place between the gas recycler 305 and the thermal energy store 303.

FIG. 4 shows another climate-control device 401. The climate-control device 401 comprises a thermal energy store 403 and a gas recycler 405. The gas recycler 405 furthermore comprises an activated carbon filter 407. The activated carbon filter 407 makes it possible, in particular, to filter carbon dioxide out of the gas mixture. It is thus advantageously possible to keep a carbon dioxide content in a passenger compartment below a critical value.

FIG. 5 shows another climate-control device 501. The climate-control device 501 comprises a thermal energy store 503 and a gas recycler 505. The thermal energy store 503 comprises an evaporator 507 and an adsorber 509. The evaporator 507 and the adsorber 509 are connected to one another by a duct (not shown), with a valve 511 being provided in the duct. The valve 511 is preferably designed as a shutoff valve and/or as a throttle valve, thereby making it possible to interrupt the connection between the evaporator 507 and the adsorber 509 or to restrict it in an infinitely variable manner. It is thus advantageously possible to adjust a cooling or heating capacity of the thermal energy store 503.

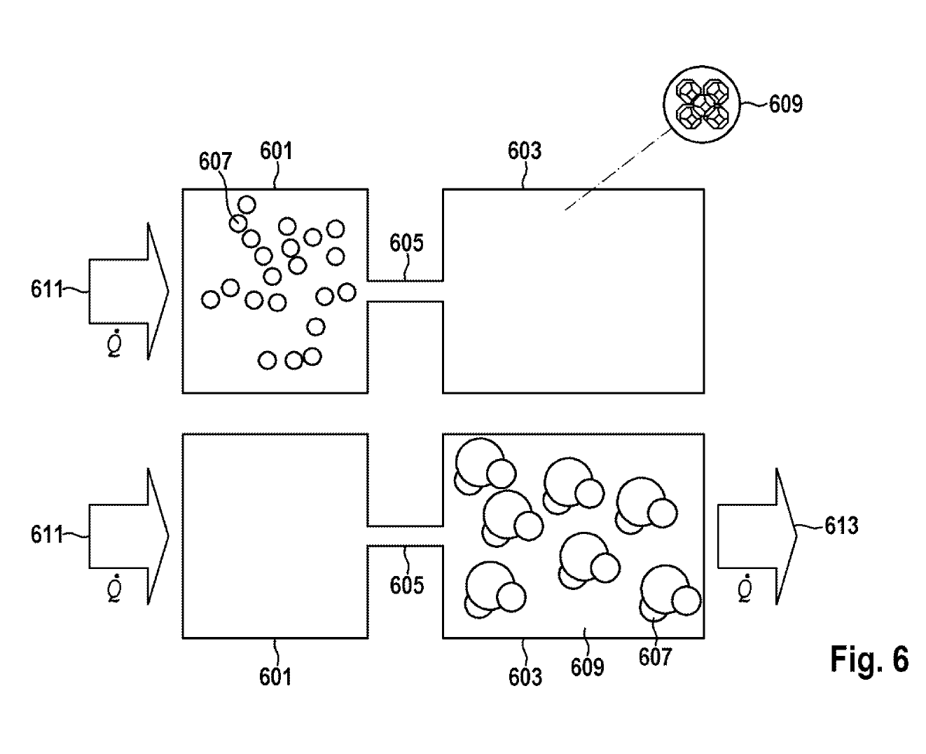

FIG. 6 shows a schematic diagram of a mode of operation of an evaporator 601 and of an adsorber 603. The adsorber 603 is connected to the evaporator 601 by a duct 605. Provision can be made, for example, to form a valve similar to valve 511 from FIG. 5 in the duct 605.

The evaporator 601 preferably comprises a working medium, in this illustrative embodiment water 607.

The adsorber 603 preferably contains an adsorbent, in this illustrative embodiment zeolite 609 as a microporous solid body.

A heat supply or a supply of thermal energy to the evaporator 601 is indicated by an arrow with the reference sign 611. A heat discharge or a discharge of thermal energy from the adsorber 603 is indicated by means of an arrow with the reference sign 613.

In a heating or cooling mode, the water 607 stored in the evaporator 601 is evaporated. The evaporation enthalpy required for this purpose is preferably taken from an air stream, which is driven through a cooling grille (not shown) of the evaporator 601, for example. This forced flow can be assisted either by the relative wind and/or additionally by a fan blower (not shown). The air cooled in this way can preferably be used for climate control of the interior, allowing a passenger compartment to be cooled, for example.

A water vapor pressure corresponding to the evaporator temperature is established in the evaporator 601. As a result of the pressure drop, the water vapor is forced into the adsorber 603 until the latter is saturated with water. That is to say, the saturation vapor pressure of the water vapor in the evaporator is reached in the adsorber 603. Since the water vapor in the adsorber is bound in the zeolite 609, condensation enthalpy and binding heat is liberated as a result. A cooling grille (not shown) of the adsorber 603 releases this heat to an air stream passing through, driven, for example, by the relative wind and/or by a fan blower. This air stream can be fed, in particular, to a passenger compartment, thus advantageously enabling the passenger compartment to be heated.

The system is preferably evacuated. That is to say that the evaporator 601 and the adsorber 603 are sealed in a vacuum tight manner relative to the environment and that a partial pressure of the air contained therein is very much lower than an ambient pressure of the vehicle. Thus, a vacuum is formed in the evaporator 601 and the adsorber 603. This has the effect that water can evaporate in the evaporator 601, even at temperatures less than 100° C. The partial pressure is preferably less than 1 bar. The partial pressure preferably approaches zero bar.

As soon as the zeolite 609 in the adsorber 603 is saturated with water, a cooling or heating capacity can no longer be provided. The zeolite 609 must therefore be regenerated. In general, such regeneration can also be referred to as drying out. Such regeneration can be accomplished by means of an electric resistance heater (not shown), for example. In this case, the zeolite 609 or, in very general terms, the adsorbent is heated up. The water is driven out of it and passes as vapor to the cooler side of the evaporator, where the water vapor re-condenses. The condensation heat liberated by the evaporator can then be used, for example, to heat up an air stream by means of which the passenger compartment can be preheated during the regeneration process in winter. After regeneration, a valve, e.g. a shutoff valve, is, in particular, closed to ensure that the zeolite 609 remains dry until the unit is put into operation for cooling or heating.

In general, a thermal energy store having an evaporator and an adsorber preferably comprises a connection for a vacuum pump for the purpose of evacuating the adsorber and the evaporator, thus ensuring that a vacuum is formed in the adsorber and in the evaporator. It is thus advantageously possible to maintain a vacuum, even over a prolonged period, since, in the event of a pressure rise, the system can be re-evacuated. A vacuum pump of this kind is preferably integrated into an appropriate system.

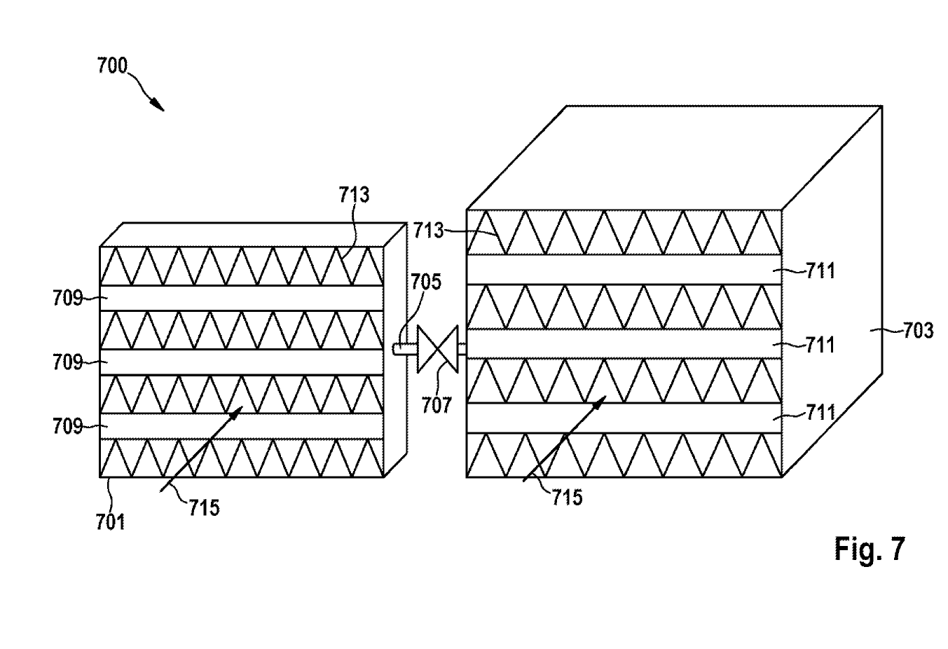

FIG. 7 shows one embodiment of a thermal energy store 700. The thermal energy store 700 comprises an evaporator 701 and an adsorber 703. The evaporator 701 is connected to the adsorber 703 by means of a duct 705. The duct 705 has a valve 707, which is designed as a shutoff valve and/or as a throttle valve.

The evaporator 701 has a plurality of ducts 709, which are arranged substantially parallel to one another and which can be referred to below as evaporator ducts. Ribs 713 in a sawtooth structure are arranged between the evaporator ducts 709. The ribs 713 can also be referred to as fins. The fins 713 are preferably thermally coupled to the evaporator ducts 709.

In a manner similar to the evaporator 701, the adsorber 703 also has a plurality of adsorber ducts 711 arranged substantially parallel to one another. A plurality of fins 713 is also arranged between the adsorber ducts 709 to enlarge a thermal exchange surface.

In the illustrative embodiment shown in FIG. 7, just three evaporator ducts 709 and three adsorber ducts 711 are shown. In an illustrative embodiment which is not shown, it is also possible for more or less than three evaporator ducts 709 or adsorber ducts 711 to be provided.

The evaporator ducts 709 and/or the adsorber ducts 711 are preferably embodied as flat ducts or as flat tubes. The adsorbed substance, e.g. water, is arranged in the evaporator ducts 709. The evaporator ducts 709 are thus filled with the adsorbed substance.

The adsorber ducts 711 are filled with an adsorbent, e.g. zeolite and/or silica gel. An air stream to be cooled or heated is indicated by an arrow with the reference sign 715. Since the working medium or adsorbent and the air stream 715 to be cooled or heated do not run parallel to one another but cross one another, such a thermal energy store 700 can also be referred to as a crossflow heat exchanger. The evaporator 701 and the adsorber 703 are thus designed as a crossflow heat exchanger.

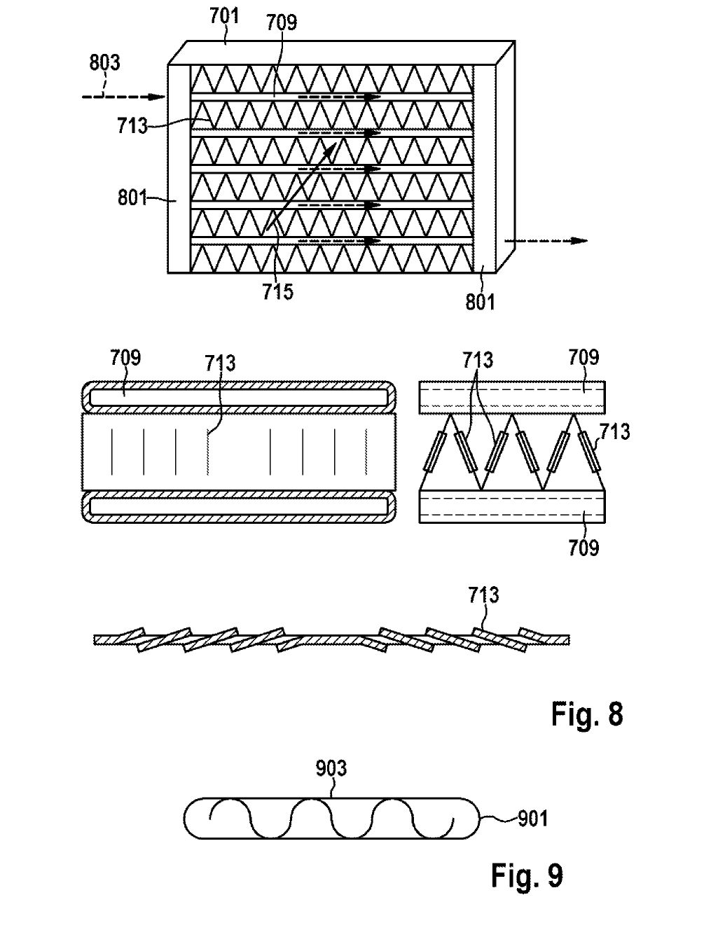

In the upper drawing, FIG. 8 shows a development of the evaporator 701 from FIG. 7. The development consists, in particular, in that a water box 801 which supplies the water for the evaporator ducts 709 is formed on a left-hand and a right-hand side of the evaporator ducts 709. A corresponding coolant flow is indicated by an arrow with the reference sign 803. In the three lower drawings in FIG. 8, various sectional views of the evaporator 701 and of the fins 713 are shown. According to one embodiment, the fins 713 can also be arranged parallel to one another.

FIG. 9 shows one embodiment of a flat duct 901 or flat tube, which can be used in an evaporator and/or an adsorber. The flat tube 901 has interior braces 903, in particular corrugated sheet-metal strips, which can be of wavy design, for example. As a result, the flat tubes 901 can advantageously withstand the negative pressure of a vacuum. In particular, the braces 903 are soldered in, e.g. in the form of corrugated sheet-metal strips. Sufficient stability under negative pressure for the flat tubes of the evaporator can also be brought about, in particular, by means of a zeolite filling. That is to say that sufficient zeolite is introduced into the flat tube to provide a supporting effect.

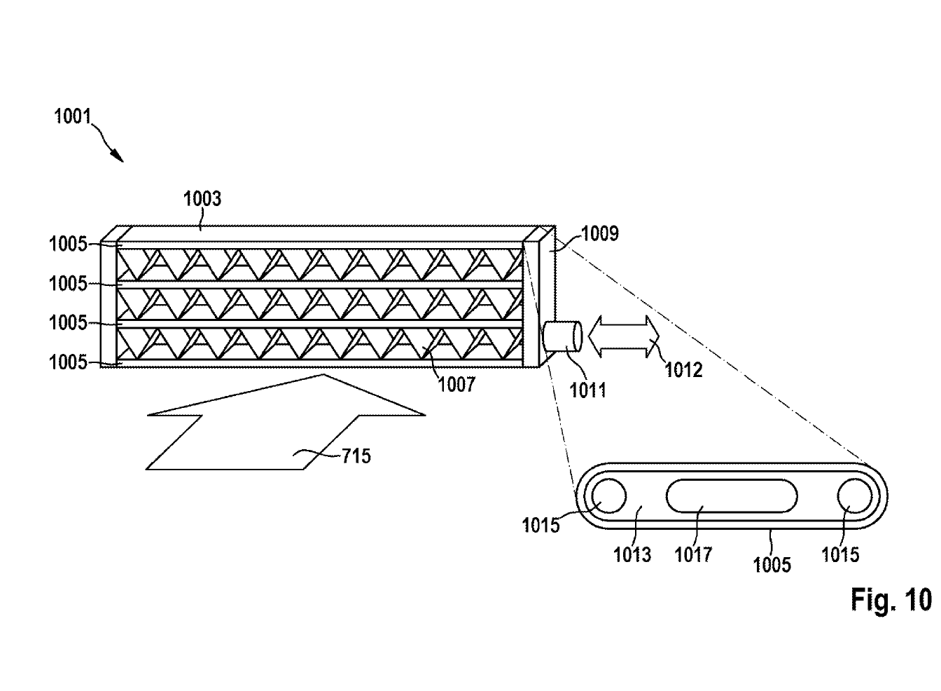

FIG. 10 shows another embodiment of a thermal energy store 1001. The thermal energy store 1001 comprises a flat-tube heat exchanger 1003. The flat-tube heat exchanger 1003 has a plurality of flat tubes 1005 substantially parallel to one another, which are connected to one another at the respective ends thereof by a connecting tube 1009. Fins 1007 are furthermore formed between the flat tubes 1005. An inlet 1011, through which water vapor, indicated symbolically by a double arrow 1012, can be introduced and discharged, is formed on a connecting tube 1009.

A sectional view of a flat tube 1005 is furthermore also shown in FIG. 10. The flat tube 1005 can preferably be produced from aluminum. A zeolite molding 1013 is arranged in the interior of the flat tube 1005 in such a way that a duct passage 1017, through which water vapor can be passed, remains free. The duct passage 1017 thus forms an aperture in the zeolite molding 1013. The flat duct 1005 is preferably cast together with a zeolite molding. In an embodiment which is not shown, it is also possible for a surface of the inside of the flat duct 1005 to be coated with zeolite. It is thus advantageously possible to achieve improved thermal coupling of the zeolite to the heat exchanger, and this advantageously increases the efficiency of the transfer of the heat output to the inlet air stream 715.

For regeneration of the zeolite and/or of the silica gel, i.e. desorption of the adsorbent, a heating wire 1015 is provided. In an illustrative embodiment which is not shown, it is also possible for a heating foil to be integrated into the zeolite or the flat duct 1005 filled with silica gel.

In another illustrative embodiment which is not shown, the evaporator comprises a nonwoven, advantageously allowing the water to be stored in an efficient way.

In another embodiment which is not shown, the evaporator ducts and/or adsorber ducts can be filled with a metal foam. In particular, a metal foam of this kind allows space-saving storage of water while, at the same time, providing a large evaporation surface to enable the evaporation enthalpy to be removed efficiently from the air stream.

The abovementioned embodiments can also be referred to as air-based systems. Here, the term “air-based” means, in particular, that the adsorption heat directly heats up the inlet air stream to the passenger compartment at the adsorbent in order to heat the interior. Moreover, the refrigerating capacity for cooling the interior or passenger compartment is taken from the inlet air stream at the evaporator. In order, therefore, to control whether the inlet air is cooled or heated, the inlet air stream is, in particular, deflected by means of flaps, ensuring that the inlet air stream is directed either via the adsorber or the evaporator.

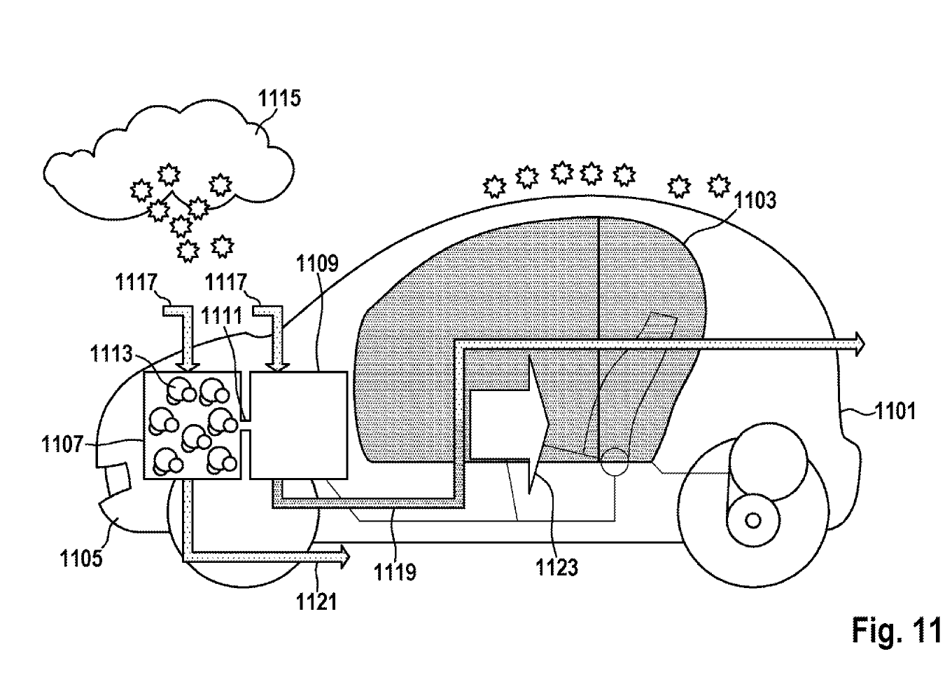

FIG. 11 shows a vehicle 1101 comprising a passenger compartment 1103. Moreover, a thermal energy store 1105 is provided, which has an evaporator 1107 and an adsorber 1109. The adsorber 1109 is connected to the evaporator 1107 by means of a duct 1111. Although not shown here, it is also possible for a valve to be provided in the duct 1111.

The evaporator 1107 is filled with water 1113. The adsorber 1109 is filled with zeolite (not shown). A sleet cloud 1115 is intended to represent symbolically that the passenger compartment 1103 needs to be heated to ensure that the occupants of the vehicle 1101 feel comfortable. For this purpose, cold exterior air 1117 is fed both to the evaporator 1107 and to the adsorber 1109. The evaporator 1107 removes heat from this cold exterior air 1117, and the adsorber 1109 releases heat to the passenger compartment 1103 via appropriate feed ducts 1119 at a higher temperature level. This heat supply is indicated symbolically by an arrow 1123.

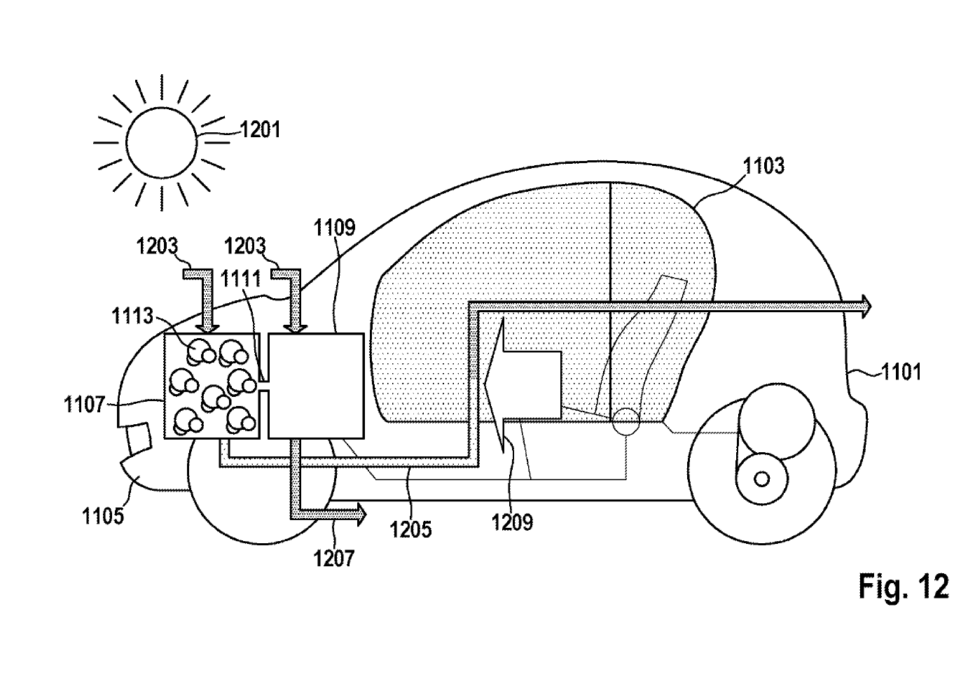

FIG. 12 shows the vehicle 1101 from FIG. 11, the requirement here being that the passenger compartment 1103 should be cooled since now the sun 1201 is shining, rather than there being a sleet cloud 1115. The evaporator 1107 removes heat from warm exterior air 1203. The exterior air which has then been cooled is then directed into the passenger compartment 1103 via feed lines or feed ducts 1205. The adsorber 1109 likewise releases the heat thereof to a second air stream, which is then released back into the environment, this being indicated symbolically by an arrow 1207. The arrow with the reference sign 1209 is intended to indicate symbolically that heat is being removed from the passenger compartment 1103.

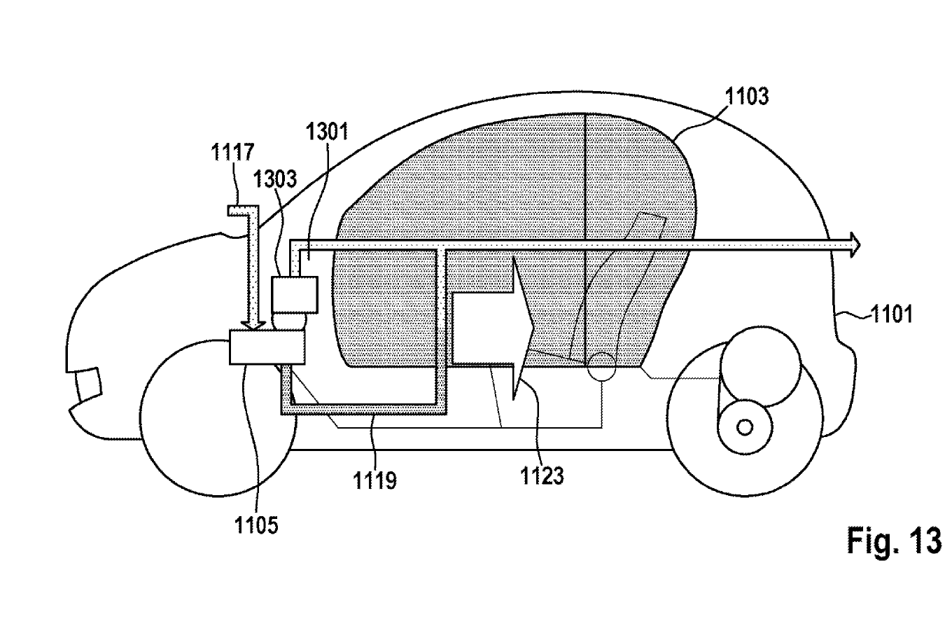

FIG. 13 shows the vehicle 1101 from FIGS. 11 and 12 with an additional gas recycler 1301. The gas recycler 1301 has an activated carbon filter 1303. The gas recycler 1301 is preferably coupled thermally to the thermal energy store 1105. A vehicle 1101 of this kind, which is shown in FIG. 13, comprising a thermal energy store 1105 and a gas recycler 1301, which together form a climate-control device, offers the advantage, in particular, that air quality in the passenger compartment 1103 in recirculated air mode can be kept at a high level, while, at the same time, a range of the vehicle 1101 can be increased or a fuel consumption can be lowered by virtue of the reduction in the demand for heating or cooling due to the recirculation of air and by virtue of the efficient energy storage.

As an alternative or in addition to the abovementioned air-based systems described, one preferred option is to provide for a heat output not to be transferred directly from the adsorber to the inlet air but initially to heat up a coolant. This leads, in particular, to a modified heat transfer geometry, in which the zeolite or silica gel is located on one side as a heat source and coolant flows past on the other side and takes up this heat. Water, in particular water containing antifreeze, is preferably used as the coolant. Such water containing antifreeze is also used, in particular, for cooling internal combustion engines. After the coolant has been heated up by the zeolite or silica gel, it can heat up the inlet air as required by means of a heating heat exchanger. The advantages of such a water-based system are a small installation space, flexible location in the vehicle and the possibility of using existing infrastructure for carrying the inlet air, e.g. the standard ventilation system of the vehicle. The zeolite store and/or the silica gel store are preferably thermally insulated, advantageously ensuring that they release almost no heat to the environment, but do so only to the coolant.

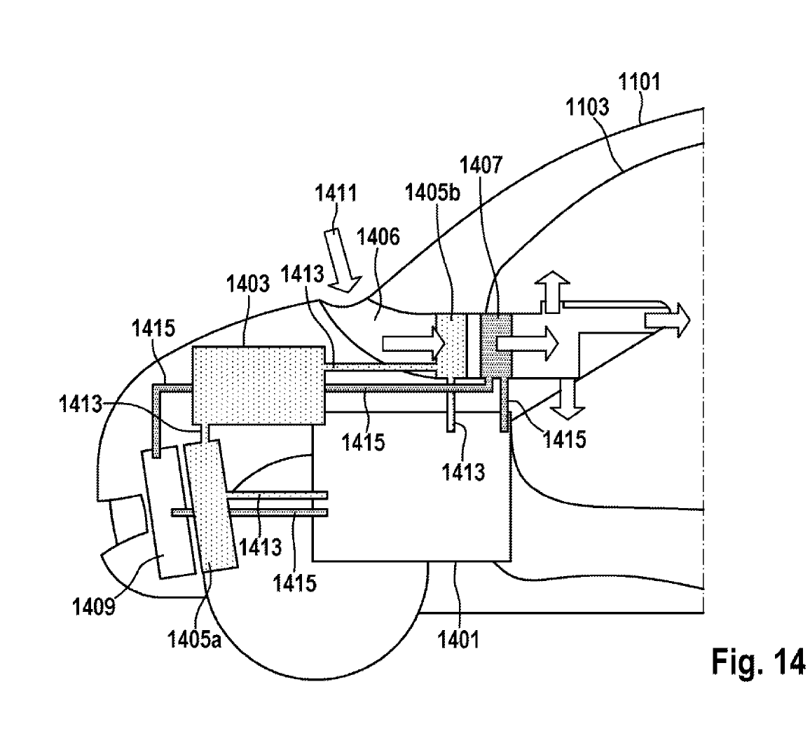

Such a system is illustrated schematically in FIG. 14. The vehicle 1101 with the passenger compartment 1103 is shown. Also provided is a thermal energy store 1401, which can also be referred to as a water-based thermal energy store. For the sake of clarity, no valves and pumps have been depicted. To regulate a refrigerating capacity, two evaporators 1405a and 1405b are provided, evaporator 1405b being arranged in an inlet air duct 1406 for the inlet air 1411. A water tank 1403 is furthermore provided, supplying water for the two evaporators 1405a and 1405b. Together with the thermal energy store 1401, the water tank 1403, the two evaporators 1405a and 1405b form a first coolant circuit 1413.

In the case of heating, evaporator 1405a must be operated in order to avoid unintentionally cooling the inlet air stream 1411.

The heat supplied by means of the thermal energy store 1101 is made available to a heating heat exchanger 1407, which is likewise arranged in the inlet air duct 1406. Also provided is a radiator grille 1409, which, together with the heating heat exchanger 1407 and the thermal energy store 1401, forms a second coolant circuit 1405. Via this second coolant circuit 1415, heat can be discharged to an adsorber of the thermal energy store 1401 and passed to the heating heat exchanger 1407. In the case of cooling, the heat arising in the adsorber (not shown) must be released to the environment at the radiator grille 1401, which can also be referred to as a front end cooler. The evaporator 1405b can also be referred to as a front-end evaporator.

In an illustrative embodiment (not shown), the heating or cooling capacity can be adjusted in the water-based system shown in FIG. 14 by regulating the cooling water supply to the adsorber by means of a water pump, thereby advantageously making it possible to influence the adsorber temperature and hence the adsorption rate.

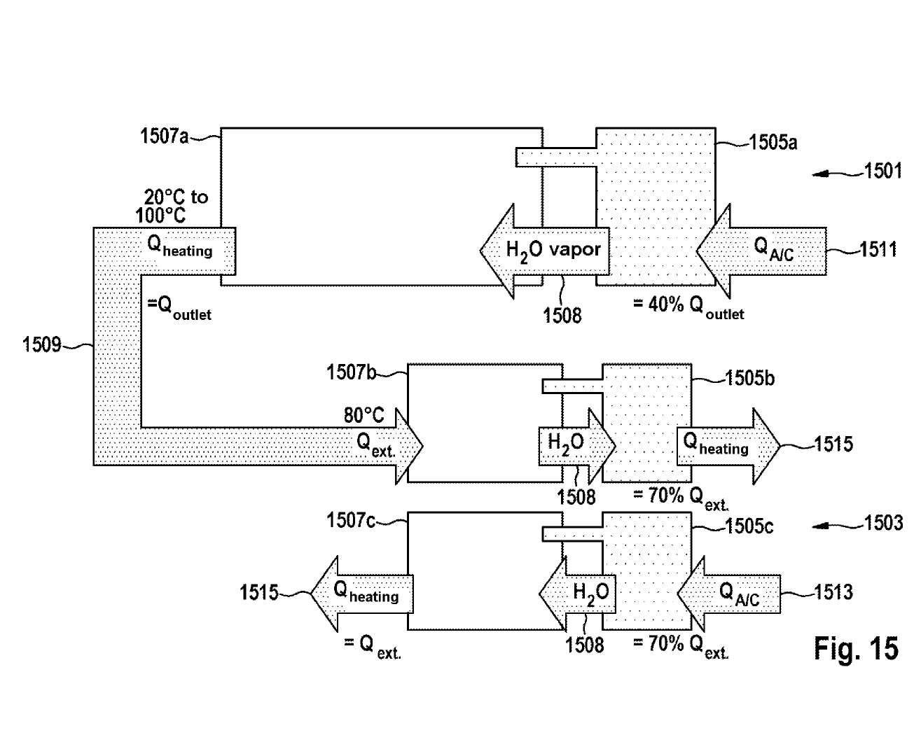

FIG. 15 shows a thermal energy store 1501, which is thermally coupled to an adsorption heat pump 1503, wherein the adsorption heat pump 1503 is, in particular, operated periodically. It is thus advantageously possible to achieve a significant improvement in cooling efficiency.

The thermal energy store 1501 comprises an evaporator/condenser unit 1505a. The evaporator/condenser unit 1505a is connected to an adsorber 1507a and can thus feed the latter with water vapor 1508.

The adsorption heat pump 1503 comprises two evaporator/condenser units 1505b and 1505c, which are respectively connected to adsorbers 1507b and 1507c, with the result that, here too, the evaporator/condenser units 1505b and 1505c feed water vapor 1508 to adsorbers 1507b and 1507c respectively.

Adsorber 1507a contains zeolite as an adsorbent. Adsorbers 1507b and 1507c each contain silica gel as an adsorbent. As an alternative, adsorbers 1507b and 1507c can contain modern zeolite types (e.g. FAU) with low desorption temperatures. It is thus advantageously possible to operate the adsorption heat pump 1503 at a lower temperature, e.g. at about 80° C., than the thermal energy store 1501, e.g. about 100° C.

Adsorber 1507 provides, in particular, a heating energy of about 20 kWh. Adsorbers 1507b and 1507c each provide, in particular, a heating energy of about 0.5 kWh.

The thermal energy store 1501 provides a heating capacity Qheating 1509 and a refrigerating capacity QA/C 1511. The heating capacity Qheating 1509 is used to operate the adsorption heat pump 1503. In this case, the adsorption heat pump 1503 achieves an additional refrigerating capacity QA/C 1513. The cooling capacities 1511 and 1513 of the thermal energy store 1501 and of the adsorption heat pump 1503 can thus be added to the overall refrigerating capacity of the system. A coefficient of performance can thus advantageously be increased by a significant amount, in particular to values greater than 1. The embodiment of an adsorption heat pump shown in FIG. 15 can also be referred to as a multi-cascade adsorption system.

The heating capacity Qheating that is formed by means of the adsorption heat pump 1503 and can be taken off is indicated by reference sign 1515.

By virtue of the combination according to the invention of an adsorption heat pump and a thermal energy store, efficiency during cooling is significantly increased. This advantageously has the effect that less energy from the energy store 1501 has to be used to cool a passenger compartment. Consequently, energy consumption during the regeneration of the adsorption store is minimized.

1. A climate-control device for a vehicle, having a thermal energy store, wherein a gas recycler is formed for conditioning a gas mixture which is situated in a passenger compartment of the vehicle.

2. The climate-control device as claimed in claim 1, wherein the gas recycler is coupled to the thermal energy store for the purpose of exchanging thermal energy.

3. The climate-control device as claimed in claim 1, wherein the thermal energy store has a cross flow heat exchanger.

4. The climate-control device as claimed in claim 1, wherein the thermal energy store has an evaporator and an adsorber connected to the evaporator.

5. The climate-control device claimed in claim 4, wherein at least the evaporator or the adsorber contains a metal foam for holding an adsorbent and an adsorbed substance.

6. The climate-control device as claimed in claim 4, wherein a valve for adjusting a cooling or heating capacity is arranged between the evaporator and the adsorber.

7. The climate-control device as claimed in claim 1, wherein an adsorption heat pump is coupled at least to the thermal energy store or to the gas recycler for the purpose of exchanging thermal energy.

8. A method for regulating a climate in a passenger compartment of a vehicle, wherein a gas mixture situated in the passenger compartment is conditioned.

9. The method as claimed in claim 8, wherein at least part of the gas mixture is removed from the passenger compartment and fed to a thermal energy store for the purpose of exchanging thermal energy.

10. The method as claimed in claim 9, wherein the part of the gas mixture which has been removed is fed back to the passenger compartment after the exchange of thermal energy.

11. The method as claimed in claim 8, wherein a carbon dioxide component of the gas mixture is at least partially filtered out of the gas mixture.

12. The method as claimed in claim 8, wherein an airborne moisture component of the gas mixture is at least partially filtered out of the gas mixture.

13. The method as claimed in claim 8, wherein an odiferous substance component of the gas mixture is at least partially filtered out of the gas mixture.
